(19) United States
(12) Patent Application Publication
(10) Pub. No.: US 2011/0263758 A1
(43) Pub. Date: Oct. 27, 2011

(54) Composites Made of Thermoplastic Polymers, Residual Oil, and Cellulosic Fibers

(76) Inventors: Qinglin Wu, Baton Rouge, LA (US); Yong Lei, King of Prussia, PA (US)

(21) Appl. No.: 12/808,390

(22) PCT Filed: Dec. 9, 2008
(86) PCT No.: PCT/US08/86057

§ 371 Date: Jun. 16, 2010

Related U.S. Application Data
(60) Provisional application No. 61/014,098, filed on Dec. 17, 2007.

(51) Int. Cl. C08J 3/21; C08L 51/06; C08K 3/34; C08L 23/06; C08L 1/00; C08L 91/00

(52) U.S. Cl. 524/14; 524/13

(57) ABSTRACT

A method is disclosed for recycling polymer containers contaminated with oil, for example used HDPE motor oil containers, in an energy efficient manner, that does not require a costly washing step. The commercial value of the polymers is preserved by converting the contaminated polymers into value-added products. Composites are made from discarded motor oil containers, the residual motor oil therein, cellulosic fibers, and blending agents or other additives. In one embodiment, the process uses the residual oil to advantage as a fiber blending agent, or to make polymer types in a blend more compatible with one another.

(In countries other than the United States:) The benefit of the 17 Dec. 2007 filing date of U.S. provisional patent application 61/014,098 is claimed under applicable treaties and conventions. (In the United States:) The benefit of the 17 Dec. 2007 filing date of U.S. provisional patent application 61/014,098 is claimed under 35 U.S.C. §119(e).

The development of this invention was partially funded by the United States Government under grant number 68-3A75-6-508 awarded by the Department of Agriculture. The United States Government has certain rights in this invention

### TECHNICAL FIELD

This invention pertains to recycling of polymers contaminated with oil, such as used motor oil containers, into composite materials.

### BACKGROUND

Over 3 billion quart-size (−0.95 liter) high-density polyethylene (HDPE) motor oil containers are used each year in the United States alone, representing about 150,000 tons of HDPE waste containers annually; and many more are produced in other countries as well. On average, each disposed container is contaminated with about 20 g of motor oil, present both as bulk liquid and as a coating of the container interior, totaling about 60,000 metric tons (20 million gallons) of motor oil residue annually in the United States alone. This residual oil is not only an environmental contaminant in its own regard; but it also typically prevents re-use of the polymer containers for other purposes. Indeed, most plastic recycling programs will not accept empty motor oil containers. A similar problem exists with containers that are made from other polymers, for example, polypropylene (“PP”), or polyvinyl chloride (“PVC”), or that contain different types of oil, such as other petroleum products or cooking oil. After use, these oil-contaminated containers typically become waste for which there are no good recycling options, and where are therefore often landfilled.

Used HDPE motor oil containers may not simply be recycled by traditional means into new motor oil containers. This seemingly simple solution encounters a substantial problem, namely, that the blow-molding process typically used in manufacturing HDPE containers requires high melt-flow characteristics, and hence employs temperatures above of 200° C. At these elevated temperatures, there is significant thermal degradation of oil residues, which imparts a strong, oily odor to the recycled polymer, severely limiting its utility.

Some prior approaches have relied on cleaning used motor oil containers prior to recycling the polymer, using cleaning methods that include: (a) using supercritical water to displace the oil from the polymer; (b) using a halogenated solvent to displace the oil from the polymer; (c) using non-halogenated (combustible) solvents to displace the oil from the polymer; or (d) blowing out the residual oil using heated air or supercritical carbon dioxide. These processes are difficult to implement on a commercial scale, are energy-intensive, each tends to create other waste products.

U.S. Pat. No. 5,711,820 discloses a method to separate and recover motor oil from contaminated polymer using CO₂ in a liquid or supercritical state.

U.S. Pat. No. 5,225,137 discloses a bottle recycling apparatus and method.

See generally D. Shipley, “Development of Reprocessing Options and End Markets for Used Oil Containers,” Final Report on behalf of the Plastics and Chemicals Industry Association et al. (2000)

Centers dedicated to recycling used motor oil containers have had limited commercial success. For example, a plant built near San Francisco, Calif. eventually withdrew from oil container recycling due to the expense of cleaning the containers. Another recycling company in Wisconsin has sporadically accepted discarded oil bottles, but its supercritical-CO₂ cleaning process has also proven to be too costly.

One alternative to expensive cleaning is simply grinding the HDPE containers along with their residual oil, and sparingly introducing the oil-containing grind into other plastic recycling streams. This approach is limited by the capacity of the recycling stream to absorb the oil contamination without adverse effect on the recycled produce.

Used motor oil can have a profound environmental impact—one gallon of motor oil has the potential to contaminate up to one million gallons of water. The current alternative to recycling, placement in landfill, is unattractive. It has been estimated that it can take 1,000 years for an HDPE motor oil container to decompose. Concerns about oil release into the soil and groundwater have prompted numerous city and county governments to prohibit motor oil containers in landfill.

An alternative to recycling and landfill is to degrade the used polymer and oil into simpler hydrocarbon liquids, fuel solids, and fuel gas.

U.S. Patent Application No. 2002/10006367 discloses a method for conversion of polymer waste into oil using super-critical or near super-critical water.

U.S. Patent Application No. 2003/10019789 discloses a method for conversion of waste polymer into gasoline, kerosene, and diesel oil fractions.

U.S. Patent Application No. 2002/0156332 discloses a method for converting waste polymer into lower molecular weight hydrocarbons, such as gasoline.

U.S. Pat. No. 5,226,926 discloses a method for converting waste polymer and spent vegetable oil into solid fuel products.

E.P. Patent Application 0636674 discloses a thermal decomposition apparatus for recycling polymer. Polymer is melted and then thermally decomposed. Gas produced by this process may be used for fuel.

U.S. Pat. No. 5,597,451 discloses a method for converting used plastic into oil through thermal decomposition.

E.P. Patent No. 1,101,812 discloses a process for recovering the oily residue from waste polymer.

These degradative processes typically require large capital investment to build processing facilities, are energy-intensive, and may themselves generate significant amounts of polluted exhaust air and other waste products. Furthermore, these degradative processes represent an economic loss in that potentially valuable polymers are converted into simpler fuel molecules.

Aside from questions of contamination, another general problem encountered in recycling polymer containers is the immiscibility of different polymer types. Structural members made of recycled polymers often suffer from a large creep under load, due to their low elastic modulus and high temperature sensitivity. Modifiers are sometimes used to improve interfacial adhesion and composite performance. Immiscibility often causes mixtures of polymer types to form separate phases, resulting in undesirably brittle products. For example, for polyethylene/polystyrene (PE/PS) blends, the Charpy impact strength can be as low as ˜5 kJ/m² when no compatibilizer is present. However, for composites modified with polystyrene/poly(ethylene/butylene)/polystyrene (SEBS), impact strength can increase to ˜20 kJ/m², presumably due to improved interfacial adhesion.

A problem related to miscibility is the difficulty in uniformly dispersing natural fibers in polymer melts to make composite materials. Fiber dispersal has previously been enhanced by treating natural fibers with agents such as stearic acid, mineral oil, organo-titanates, nano-clay, and maleated ethylenes. Wood fiber/plastic composites (WPCs) have proven commercially successful in products such as lumber, decking, railing, window profiles, wall studs, door frames, furniture, pallets, fencing, docks, siding, architectural profiles, boat hulls, and automotive components. The global WPC market is currently experiencing double digit annual growth. Cellulosic natural fibers that may be used in WPCs include those from softwood, hardwood, bamboo, rattan, rice straw, wheat straw, rice husk, bagasse, cotton stalk, jute, hemp, flax, kenaf, and banana.

There remains an unfilled need for improved methods to facilitate the recycling of motor oil-contaminated polymer containers. There is also an unfilled need for improved methods to facilitate the blending of different polymer types. There is also an unfilled need for improved methods to facilitate the manufacture of polymer/cellulosic fiber composites.

### SUMMARY OF THE INVENTION

We have discovered a method for recycling polymer containers contaminated with oil, for example used HDPE motor oil containers, in an energy efficient manner, that does not require a costly washing step. The commercial value of the polymers is preserved by converting the contaminated polymers into value-added products. In one embodiment, we have made novel composites comprising discarded motor oil containers, the residual motor oil therein, cellulosic fibers, and blending agents to reduce incompatibilities not only between different polymer types, but also between polymer and cellulose fiber. The process requires neither cleaning nor other extensive removal of residual oil from polymer containers. In one embodiment, the process uses the residual oil to advantage as a fiber blending agent, or as a compatibilizer between different polymer types.

Optionally, cellulosic fibers and blending agents, reactive coupling agents and additives such as nano-clay particles and maleic anhydride may be added. Without wishing to be bound by this hypothesis, we believe that the residual motor oil acts as a plasticizer that alters the melting behavior and mechanical properties of the melted HDPE. In combination with other blending additives, such as maleated or carboxylated polyolefins or elastomers, titanium-derived mixtures, and functional co-polymers, the invention also allows blending of HDPE with other, otherwise incompatible polymer types, such as polyesters, polyamides, and polycarbonates. We believe that the motor oil plasticizer also improves the dispersion of natural cellulosic fibers added to the blends, leading to more uniform and less brittle composites. Improvements result in the recycled polymer's strength, tensile modulus, and flexural modulus, impact resistance, and water resistance. Neither motor oil nor any heavy metal-containing additives leach from the novel HDPE/cellulosic fiber composites to any significant degree.

The composites are heat- and water-stable. The cellulosic fibers help to absorb residual oil during compounding. The oil can act as a lubricant to improve extruder output for a given torque, to reduce temperatures in the extruder, to improve the dimensional stability of an extruded form, and to improve the surface appearance of the products. Metals present in the oil, such as zinc or calcium, may help to improve the long-term durability of the composites. Adding a clay or nanoclay such as montmorillonite can help to improve the composite's modulus and fire resistance.

In prototype embodiment, discarded HDPE motor oil containers were gravity-drained to remove most of the excess free-flow oil therein. Devices such as BOB, the Bottom of the Bottle Oil Recovery System (Plastic Oil Products, Vista, Calif.) may be used for this purpose. (The separately recovered oil may then be directly recycled itself, with filtering, refining, etc. as required.) The drained containers, with oil residue comprising up to 12% of the total weight, were granulated into flakes using a plastic granulator (e.g., Granu-Grinder from CW Branbender Instruments). Melt compounding of the ground HDPE (with residual oil), natural fiber (0-70% of the composite weight), and additives (0-10%) was performed using an intermesh, counter-rotating twin-screw extruder (e.g., Intelli-Torque Plasti-Corder) with a screw speed of 30-250 rpm. Compounding was performed at temperatures ranging from about 150° C. to about 190° C. for polymers such as HDPE, PP, and PVC. The compounding temperature was elevated to about 210° C. to 270° C. when compounding with engineering polymers such as Nylon, PS and PET. The extrudates were quenched in a cold water bath, and then pelletized into granules. After being oven-dried at ˜100° C. overnight, the granules were injection-molded into standard mechanical test specimens using an Injection Molding Machine (Batenfeld Plus 35, Germany). Injection and mold temperatures were about 190° C. and about 68° C., respectively. Alternatively, the pellets can be used to produce a finished product through profile extrusion, injection molding, and other techniques otherwise known in the art.

Natural fibers used in the blending may, for example, be selected from softwood; hardwood, bamboo, rattan, rice straw, wheat straw, rice husk, bagasse, cotton stalk, jute, hemp, flax, kenaf, and banana.

Additives used in the blending may, for example, be selected from stearic acid, organo-titanates (e.g., Ken-React LICA 09), nano-clay, maleated ethylenes, maleic anhydride, styrene/ethylene-butylenes/styrene triblock copolymer (SEBS), ethylene/propylene/diene terpolymer (EPDM), ethylene/octene copolymer (EOR), ethylene/methyl acrylate copolymer (EMA), ethylene/butyl acrylate/glycidyl methacrylate copolymer (EBAGMA), Surlyn ionomers, Maleated ethylene/propylene elastomers (EPR-g-MAs), talc, heat stabilizers, pigments, dyes, UV stabilizers, fire retardants (e.g., zinc borate), calcium borate, inhibitors of decay (e.g., mold, mildew, wood-destroying insects) and other additives.

The novel composites may generally be used for applications where other wood fiber/plastic composites have been used, including for example products such as lumber, furniture, posts, decking, railing, window profiles, wall studs, door frames, furniture, pallets, fencing, docks, siding, architectural profiles, boat hulls, and automotive components.

### BRIEF DESCRIPTION OF THE DRAWINGS

FIGS. 1(a) and (b) depict the effects of residual oil loading level on the melt flow index of silver-colored oil container HDPE, and of its wood flour-reinforced composites. Oil percentage is based on HDPE weight.

FIGS. 2(a) and (b) depict the effect of wood flour loading on (a) tensile, flexural, and impact strength; and (b) tensile and flexural modulus of oil container/wood composites. The loading of PE-g-MA was fixed at 8%, based on the wood flour weight.

FIGS. 3(a) and (b) depict the effect of MA content on (a) tensile, flexural, and impact strength; and (b) tensile and flexural modulus of silver-colored oil container/wood flour (60/40 w/w) composites. The loading of oil was fixed at 6% oil based on oil container weight.

FIGS. 4(a) and (b) depict the influence of coupling agents on (a) moisture content and (b) thickness swelling of oil container polymer/wood flour composites. (“CA”: coupling agent).

FIGS. 5(a) and (b) depict the influence of nanoclay on the mechanical properties of silver-colored oil-HDPE/wood 50/50 composites: (a) flexural, tensile, and impact strength; and (b) flexural and tensile modulus.

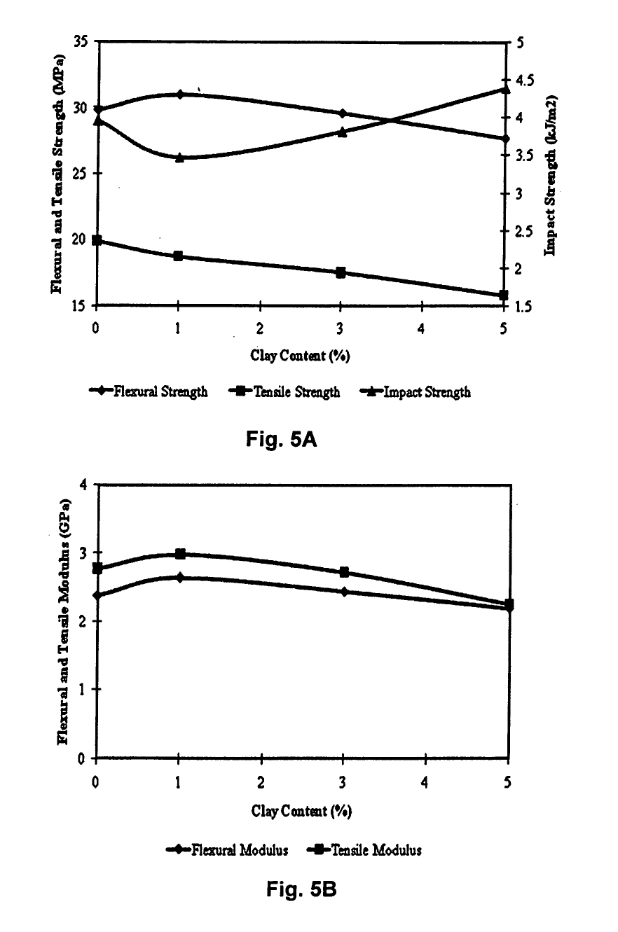

### MODES FOR CARRYING OUT THE INVENTION

### Example 1

### Polymer/Wood/Oil Composites

Quart-size HDPE motor oil containers were obtained from an oil change station in Baton Rouge, La. The sample primarily comprised automobile engine oil containers from a single manufacturer (Castol®). The containers were separated by color (silver, black, white) to investigate the possible significance, if any, of container color. Free-flowing oil in each bottle was drained into a glass beaker at room temperature. The bottles were then washed with xylenes (Mallinckrodt Chemicals) to determine initial residual oil loading, and also to obtain clean containers for comparisons. The washed containers were oven-dried at 80° C. for 8 hours, and then granulated to produce flakes 2-10 mm in diameter, with varying thicknesses. The flakes were then combined with wood fiber, motor oil, and additives as described below. The size of the flakes depends on the process apparatus and process parameters used, and in general will be ˜2 cm or smaller in diameter. (“Diameter” is used in the general sense to refer to the largest dimension across the flake, and does not imply that a flake has any particular shape.)

Wood/polymer composites (WPC) were created with used HDPE oil containers and wood fiber at weight ratios of 80:20, 70:30, and 60:40; with two motor oil loading levels (0% and 6% of the HDPE plastic weight), and with maleated polyethylene (MPAE G2608, from Eastman Chemical Company, a macromolecular coupling agent that improves compatibility between HDPE and wood fibers) at 8% of the wood fiber weight in all cases. Wood fiber was 20 mesh pine fiber from American Wood Fiber Company (Madison, Wis.). The mixture was compounded with an intermesh, counter-rotating twin-screw extruder (Intelli-Torque Plasti-Corder) with a screw speed of 50 rpm at 190° C. The polymer flakes and MAPE were premixed and fed to the extruder together using a single screw feeder. Wood fiber was fed separately with a single screw extruder. The motor oil wad fed with a micro-flow liquid pump to control the feed rate. The extrudates were quenched in a cold water bath, and were then pelletized into granules. After being oven-dried at ˜100° C. overnight, the granules were injection-molded into standard mechanical tests specimen forms using an Injection Molding Machine (Batenfeld Plus 35, Germany). Injection and mold temperatures were about 190° C. and about 68° C., respectively.

### Example 2

### WPC Composite Melt Flow Index Characterization

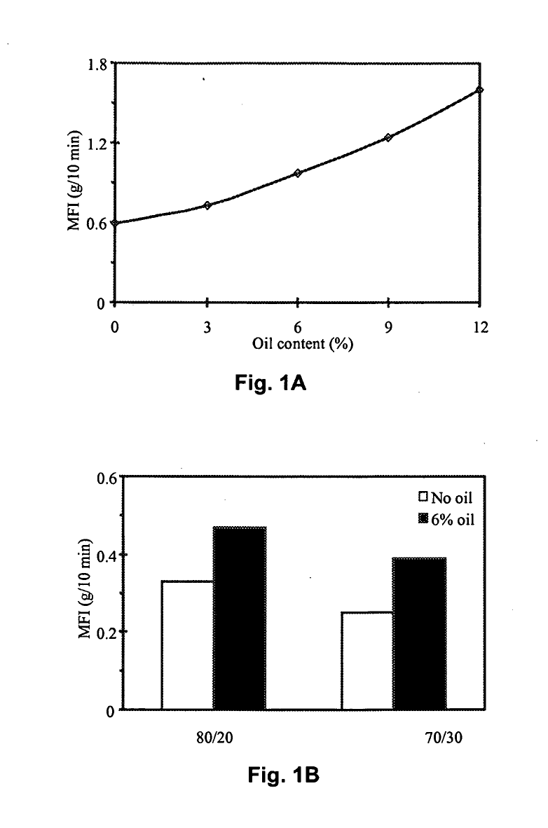

The melt flow indices (MFI) of the blends were measured (ASTM D1238) using an extrusion plastometer MP600 (Tinius Olsen Inc., Horsham, Pa.) at 190° C. with a 2.16 kg load. MFIs at 190° C. for the silver oil container HDPE and its composites are shown in FIG. 1. The MFI of the polymer increased linearly with increased oil loading (FIG. 1a). The MFI of the polymer/wood flour composites also increased with increased oil loading (FIG. 1b). The residual oil thus acted as a plasticizer, increasing polymer melt flowability and processability. Adding oil in an amount equal to 6% of the polymer by weight increased the MFI of the composites by 42.4% for the HDPE:wood flour 80/20 system, and by 56% for the HDPE:wood flour 70/30 system.

### Example 3

### Characterization of Composite Flexural and Tensile Properties

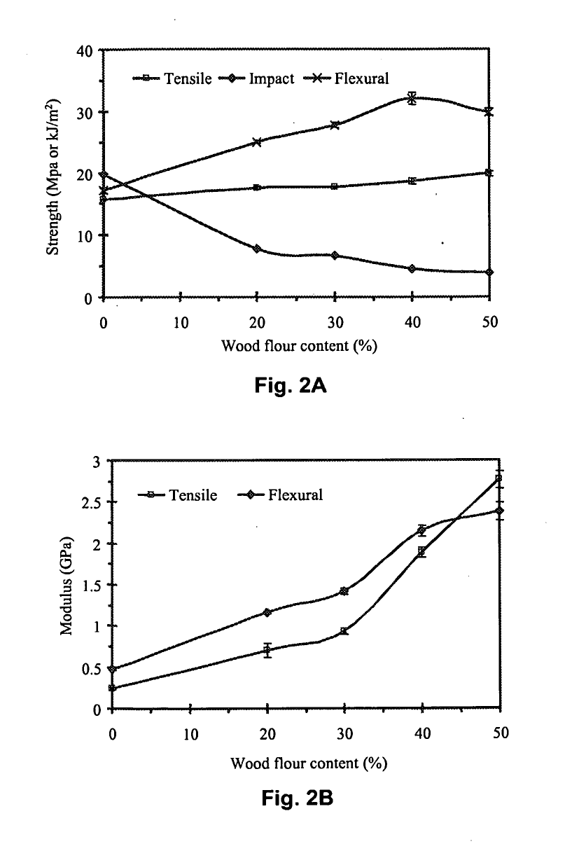

Flexural and tensile properties were measured according to ASTM D790-03 and D638-03, respectively, using an INSTRON machine (Model 1125, Boston, Mass.). For each blend, five replicates were tested. A TINIUS 92T impact tester (Testing Machine Company, Horsham, Pa.) was used for the Izod impact test. All samples were notched at the center point of one longitudinal side according to the ASTM D256. Five replicates were tested for each treatment level. The influence of wood flour percentage on composite mechanical properties is shown in FIG. 2. Increasing the wood flour loading increased the flexural strength up to a maximum at about 40% wood flour. Tensile strength did not depend strongly on wood flour loading. Impact strength first dropped quickly, and then decreased more slowly when at wood flour levels over 20%. The flexural and tensile strengths of the composites increased by 87.4% and 18.6%, respectively, with 40% wood flour. The addition of wood flour significantly increased the tensile and flexural modulus, especially at levels over 30% wood flour (FIG. 2b). The flexural modulus increase slowed at wood flour levels above 40% of the HDPE mass. The flexural and tensile moduli of the composites increased by 354.2% and 685.0%, respectively, by the addition of wood flour to 40% of the HDPE mass.

### Example 4

### WPC Composites made with Coupling Agents

Composites were created with a 60:40 ratio of HDPE to wood pine fiber (20 mesh from American Wood Fiber Company, Madison, Wis.), to which were added motor oil (6% of polymer weight), Dicumyl Peroxide (DCP, Aldrich Chemical Company, 0.4% of total composite weight, a free radical initiator), and maleic anhydride (0%, 1%, 2%, or 3% of total composite weight, MA, an in situ coupling agent for enhancing bonding strength between wood and polymer). The mixture was compounded with an intermesh, counter-rotating twin-screw extruder (i.e., Intelli-Torque Plasti-Corder), with a screw speed of 50 rpm at 190° C. The polymer, maleic anhydride, and DCP were premixed and fed to the extruder together using a single screw feeder. Wood fiber was fed separately with a single screw extruder. The motor oil was fed with a micro-flow liquid pump to control the feeding rate. The extrudates were quenched in a cold water bath and then pelletized into granules. After being oven-dried overnight at ˜100° C., the granules were injection-molded into standard mechanical test specimens using an Injection Molding Machine (Batenfeld Plus 35, Germany). Injection and mold temperatures were ˜190° C. and ˜68° C., respectively.

### Example 5

### WPC/Coupling Agent Composite Flexural and Tensile Characterization

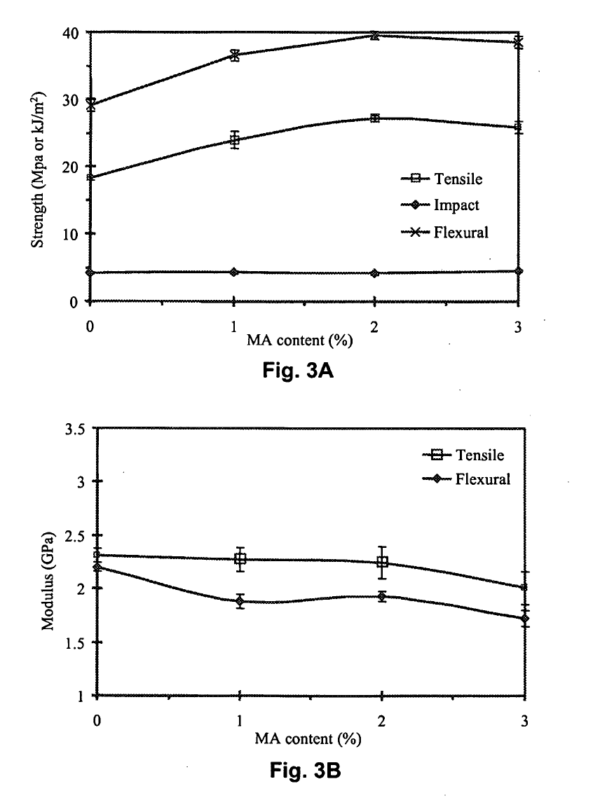

Flexural and tensile properties were measured according to ASTM D790-03 and D638-03, respectively, using an INSTRON machine (Model 1125, Boston, Mass.). Five replicates were tested for each blend. A TINIUS 92T impact tester (Testing Machine Company, Horsham, Pa.) was used for the Izod impact test. All samples were notched at the center point of one longitudinal side according to ASTM D256. FIG. 3 depicts the influence of maleic anhydride (MA) content on mechanical properties of the oil container HDPE/wood (60/40 w/w) composites. Both tensile and flexural strength increased with increased MA loading, until a maximum was reached at ˜2% MA by weight. The addition of MA hardly affected impact strength. At 2% MA, tensile and flexural strengths increased by 49.2% and 35.7%, respectively. The addition of MA up to 2% did not lower the flexural modulus of the composites, and lowered the tensile modulus slowly, as shown in FIG. 3b. Table 1 lists the measured mechanical properties of oil container/wood flour (60/40 w/w) composites. Compared with the composite containing 3.2% PE-g-MA, the composite with 2% MA had significantly higher tensile strength, flexural strength, and tensile modulus. There was no significant difference in impact strengths, however. We speculate that the different mechanical properties resulted from the higher crystallinity of the HDPE/MA system over that of the PE-g-MA system, in addition to good interfacial compatibility. Therefore, MA is preferred over PE-g-MA to enhance oil container/wood flour composites containing residual oil. We speculate that residual oil reacts with MA during reactive extrusion, in the presence of the DCP initiator.

TABLE 1
Mechanical Properties of Oil Container/Wood
(60/40 w/w) Composites*

| | Flexural | | Tensile | | Impact |
|---|---|---|---|---|---|
| | Strength | Modulus | Strength | Modulus | strength |
| Coupling agent | (MPa) | (GPa) | (MPa) | (GPa) | (kJ/m²) |
| none | 29.2(1.0) | 2.20(0.04) | 18.2(0.2) | 2.31(0.07) | 4.2(0.2) |
| 3.2% PE-g-MA | 32.1(0.9) | 2.15(0.07) | 18.6(0.4) | 1.88(0.26) | 4.5(0.2) |
| 2% MA | 39.6(0.6) | 1.93(0.05) | 27.1(0.5) | 2.25(0.15) | 4.1(0.2) |

*Percentages of PE-g-MA and MA were based on the total weight of oil container plastics and wood flour. Values in parentheses are standard deviations.

### Example 6

### Leaching Tests

Leaching tests were carried out according to AWPA Standard E11-06, “Standard Method of Determining the Leachability of Wood Preservatives,” except for the sample sizes and numbers. For each treatment level, two samples 60 mm×12.5 mm×3 mm were tested, using a desiccator with impregnation and vacuum systems. After the samples were leached in 300 ml deionized water for multiples of 48 hours, the leachate was removed and replaced with 300 ml fresh deionized water. 300 ml leachate samples were collected in this manner at 48, 96, and 144 hours, respectively. The leachates were acidified with sulfuric acid before drawing a 15 ml aliquot for an Inductively Coupled Plasma (ICP) test. The control samples were (1) deionized water, and (2) an engine oil-water mixture obtained by acidifying 3.18 g engine oil in 25 ml 98% sulfuric acid for 24 hours, and then diluting to 300 ml with deionized water. Results are shown in Table 2.

TABLE 2
Metal Concentrations of Various Leachates

| | Time | Metal concentration (ppm) | | | | |
|---|---|---|---|---|---|---|
| Sample | (h) | Ca | Mg | P | Pb | Zn |
| Deionized water | 0 | 0.024 | 0.001 | 0 | 0 | 0.002 |
| Engine oil | 0 | 78.329 | 0.620 | 26.365 | 1.743 | 26.155 |
| Oil container/wood | 48 | 1.616 | 0.082 | 0.053 | <0.01 | 0.525 |
| (60/40) | 96 | 0.398 | 0.026 | <0.01 | <0.01 | 0.046 |
| 300 ml leachate | 144 | 0.445 | 0.028 | <0.01 | <0.01 | 0.046 |
| Oil container/wood/ | 48 | 1.001 | 0.072 | <0.01 | <0.01 | 0.387 |
| PE-g-MA | 96 | 0.474 | 0.028 | <0.01 | <0.01 | 0.036 |
| (60/40/3.2) | 144 | 0.481 | 0.027 | <0.01 | <0.01 | 0.019 |
| 300 ml leachate | | | | | | |
| Oil container/wood/ | 48 | 0.818 | 0.047 | <0.01 | <0.01 | 0.186 |
| MA (60/40/2) | 96 | 0.331 | 0.016 | <0.01 | <0.01 | 0.022 |
| 300 ml leachate | 144 | 0.423 | 0.015 | <0.01 | <0.01 | 0.025 |

The engine oil contained about 78.3 ppm calcium, 26.4 ppm phosphorus, 26.2 ppm zinc, and 1.75 ppm lead. The concentration of lead in leachate from the composites was below the test's 0.01 ppm detection limit. We observed a thin oil film on the HDPE oil container/residual oil leachate, but none from the HDPE oil container/residual oil/wood flour composites.

### Example 7

### Water Absorption and Swelling Tests

Water absorption and swelling tests were conducted in two stages. The samples were conditioned at 100° C. until they reached a constant weight, and were then placed in vacuum for 30 minutes. Following vacuum, the samples were immediately impregnated with water by submersion at room temperature. At 10-day intervals, the samples were withdrawn from the water, surface water was removed, and the samples were weighed and their dimensions were measured. Three and nine replicates were measured to determine weight and thickness, respectively. After testing, the samples were again conditioned at 100° C. until they reached a constant weight, and the weights were again recorded.

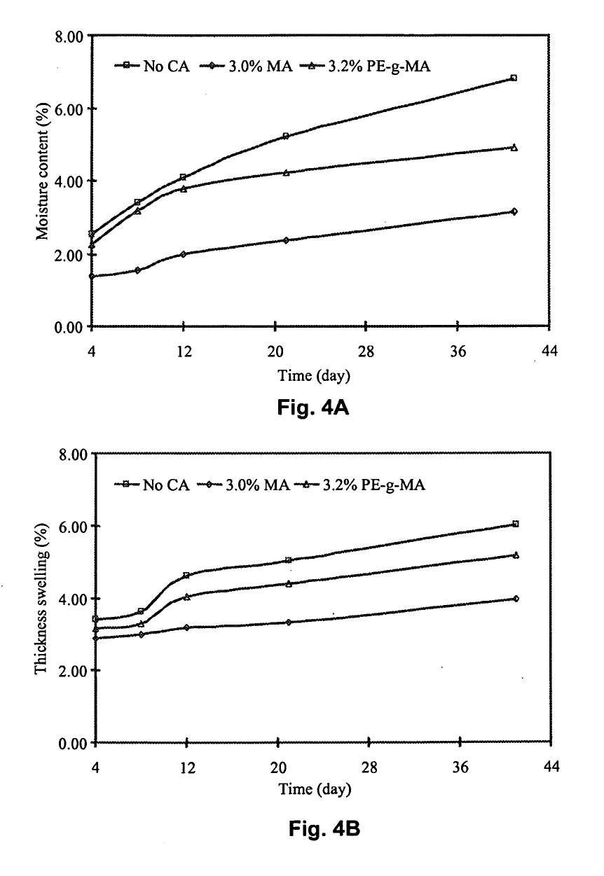

The influence of coupling agents on the moisture stability of the oil container/wood flour composites is shown in FIG. 4. Both absorbed moisture content (MC) and thickness swelling (TS) of the composites was reduced by coupling agents. A preferred coupling agent in these tests was MA. After soaking for 12 hours, the composite without coupling agents absorbed about 4% water, while the 3.0% MA-treated composite absorbed only about 2% water. The difference in moisture content increased with increased soaking time, as shown in FIG. 4a. The difference in thickness swelling between the composite without coupling agents and composites containing coupling agents increased after about 8 hours of soaking (FIG. 4b). We speculate that the improved moisture stability of the composites resulted from improved compatibility between the hydrophobic plastic matrix and the hydrophilic wood flour. The MA appeared to enhance compatibility better than the PE-g-MA.

### Example 8

### WPC/Nanoclay Composites

Composites were created with a 50:50 ratio of HDPE to wood pine fiber (20 mesh from American Wood Fiber Company, Madison, Wis.), 6% motor oil (based on polymer weight), 5% MAPE (G2608 from Eastman Chemical Company), and nano clay from Southern Clay, (0%, 1%, 3%, or 5% based on the total composite weight). The compounding was performed using an intermesh, counter-rotating twin-screw extruder (Intelli-Torque Plasti-Corder) with a screw speed of 50 rpm at 190° C. The clay and MAPE were compounded first. The HDPE and clay-MAPE mixture were premixed and fed to the extruder together using a single screw feeder. Wood fiber was fed separately with a twin screw extruder. The motor oil was fed with a micro-flow liquid pump to control the feeding rate.

The extrudates were quenched in a cold water bath and then pelletized into granules. After being oven-dried at ˜100° C. overnight, the granules were injection-molded into standard mechanical tests specimens using an Injection Molding Machine (Batenfeld Plus 35, Germany). Injection and mold temperatures were about ˜190° C. and ˜68° C., respectively.

### Example 9

### Oil-Container HDPE and Recycled HDPE Formulation

Quart-size HDPE motor oil containers were gravity-drained and granulated to produce 2-10 mm diameter flakes. These flakes were then combined with wood fiber and additives to produce various composites as discussed below.

In series of examples, granulated oil container HDPE (O-HDPE) containing about 6% motor oil by weight; natural color recycled HDPE pellets (R-HDPE) with a melt index of 0.7 g/10 min (190° C., 2.16 kg) from Envision Plastics company, Reidsville, N.C., USA; wood flour (20 mesh from American Wood Fiber Company, Madison, Wis.); and additive(s) were compounded at selected proportions through a Micro-27 extruder from American Leistritz Extruder Corporation (Somerville, N.J., USA) with a temperature profile of 130-150-160-170-180-190-190-190-180-180-180° C. and a screw rotating speed of 100 rpm. A 75 mm×5 mm profile die was used. The weight ratio of O-HDPE/Recycled HDPE/wood flour was 25/25/50 in each example in this series of tests. The additives included maleic anhydride (MA, purity 99+% from Spectrum Quality Products, Inc., Gardena, Calif., USA); maleated polyethylene (PE-g-MA) compatibilizer (G-2608, with a melt index of 8 g/10 min at 190° C. and 2.16 kg, and an acid number of 8 mg KOH/g, from Eastman Chemical Company, Kingsport, Tenn., USA); and lubricant (organic lubricant WP 2200 from Lonza Inc., Williamsport, Pa., USA). MA or PE-g-MA loading was 2%, and lubricant loading was 7%, based in either case on the total weight of polymer and wood flour. A dicumyl peroxide (DCP) initiator from Aldrich Chemical Company, Saint Louis, Mo., USA, was for composites containing MA, at a loading of 0.5% based on the total weight of polymer and wood flour.

### Example 10

### Characterization of Oil-Container HDPE and Recycled HDPE Flexural and Tensile Characteristics

Flexural and tensile properties were measured according to ASTM D790-03 and D638-03, respectively, using an INSTRON machine (Model 1125, Boston, Mass.). Five replicates were tested for each blend. A TINIUS 92T impact tester (Testing Machine Company, Horsham, Pa.) was used for the Izod impact test. All samples were notched at the center point of one longitudinal side according to ASTM D256. The main mechanical properties of extruded composite panels are listed in Table 3. Compared with the R-HDPE/O-HDPE/wood/PE-g-MA (25/25/50/2 w/w) system, the R-HDPE/O-HDPE/wood/MA (25/25/50/2 w/w) composite panel had higher flexural strength, higher flexural modulus, and higher impact strength. Thus maleic anhydride is a preferred coupling agent for improving bonding between wood fiber and polymer in the presence of oil.

TABLE 3
Mechanical Properties of Plastic/Wood Flour Composite Panels*

| | Flexural | Flexural | Impact |
|---|---|---|---|
| | strength | modulus | strength |
| System | (MPa) | (GPa) | (kJ/m²) |
| R-HDPE/O-HDPE/ | 20.8 (1.0) | 2.18 (0.13) | 3.0 (0.3) |
| wood/MA | | | |
| (25/25/50/2) | | | |
| R-HDPE/O-HDPE/ | 16.3 (1.5) | 1.82 (0.13) | 2.3 (0.2) |
| Wood/PE-g-MA | | | |
| (25/25/50/2) | | | |

*The percentage of coupling agent is based on the total weight of polymer and wood flour. Values in parentheses are standard deviations.

### Example 11

### Decay Resistance

Future testing, to be conducted in accordance with protocols otherwise standard in the art, will confirm the resistance of the novel compositions against decay caused by fungus, and against decay caused by wood-consuming insects such as termites.

### Example 12

### Thermogravimetric Analysis Resistance

Thermogravimetric testing showed that the oil in the composites was stable below ˜200° C.; and that the oil found in the composites did not have a significant effect on the decomposition of the polymer and wood components of the composites, as compared to that from otherwise-similar composites that lacked residual oil (data not shown).

The complete disclosures of all references cited in this specification, including the complete disclosure of priority application 61/014,098, are hereby incorporated by reference. In the event of an otherwise irreconcilable conflict, however, the present specification shall control.

We claim:

1. A process comprising the steps of:
(a) mechanically reducing a plurality of objects comprising a thermoplastic polymer into flakes; wherein at least some of the objects are larger than 2 cm in diameter; wherein the flakes are about 2 cm in diameter or smaller; wherein an oil adheres to at least some of the polymeric objects; wherein the oil also adheres to the flakes after the mechanical reducing step; and wherein no washing step that employs a solvent or that employs a surfactant is used to remove oil from the polymeric objects or to remove oil from the flakes;
(b) mixing the flakes and adhering oil with cellulosic fibers;
(c) heating the mixture of flakes, oil, and cellulosic fibers above the melting point of the polymer;
(d) subsequently cooling the mixture below the melting point of the polymer; whereby a solid composite material is formed, comprising an admixture of polymer, oil, and cellulosic fibers.

2. The composite material formed by the process of claim 1.

3. The method of claim 1, additionally comprising a step, prior to said heating step, of separating some of the oil from the objects or from the flakes, by allowing some of the oil to drain under gravity or by centrifuge.

4. The method of claim 1, wherein the cellulosic fibers are selected from the group consisting of softwood, hardwood, bamboo, rattan, rice straw, wheat straw, rice husk, bagasse, cotton stalk, jute, hemp, flax, kenaf, and banana.

5. The method of claim 1, additionally comprising a step, prior to said cooling step, of adding to the mixture or adding to one or more components of the mixture, an additive selected from the group consisting of stearic acid, an organo-titanate, a clay, a nano-clay, maleated ethylene, maleic anhydride, styrene/ethylene-butylenes/styrene triblock copolymer, ethylene/propylene/diene terpolymer, ethylene/octene copolymer, ethylene/methyl acrylate copolymer, ethylene/butyl acrylate/glycidyl methacrylate copolymer, a thermoplastic ionomer, a maleated ethylene/propylene elastomer, talc, a heat stabilizer, a pigment, a dye, a UV stabilizer, a fire retardant, calcium borate, and zinc borate.

6. The method of claim 1, wherein the thermoplastic polymer comprises high density polyethylene.

7. The method of claim 6, additionally comprising a step, performed prior to or during said heating step, of mixing with the high density polyethylene a polymer selected from the group consisting of virgin, used, or recycled: low-density polyethylene, polypropylene, poly(ethylene terephthalate), nylon, polycarbonate, and polystyrene.

8. The method of claim 1, wherein the objects comprise used, high density polyethylene motor oil containers, with adhering motor oil.

9. The method of claim 1, wherein the thermoplastic polymer comprises polypropylene or poly(vinyl chloride).

10. The method of claim 1, wherein said mixing step, said heating step, or both are conducted in a twin-screw compounding extruder or a twin-screw compounding mixer.

11. The method of claim 1, additionally comprising a step of profile extrusion, compression molding, or injection molding so that the solid composite material forms in a selected shape.

12. The method of claim 1, additionally comprising a step, prior to said cooling step, of adding maleic anhydride to the mixture or adding maleic anhydride to one or more components of the mixture.
